(19) United States
(12) Patent Application Publication
(10) Pub. No.: US 2015/0063339 A1
(43) Pub. Date: Mar. 5, 2015

(54) METHOD AND APPARATUS FOR CONFIGURING WIRELESS COMMUNICATION USING DEVICE NAMES IN ELECTRONIC DEVICE

(71) Applicant: SAMSUNG ELECTRONICS CO., LTD., Gyeonggi-do (KR)

(72) Inventors: Sanghyun HAN, Gyeonggi-do (KR); Suckho SEO, Gyeonggi-do (KR); Sungho PARK, Gwangju (KR); Donghyoun SON, Gyeonggi-do (KR); Jiryang CHUNG, Gyeonggi-do (KR)

(73) Assignee: SAMSUNG ELECTRONICS CO., LTD.

(21) Appl. No.: 14/476,473

(22) Filed: Sep. 3, 2014

(30) Foreign Application Priority Data
Sep. 3, 2013 (KR) 10-2013-0105237

(51) Int. Cl. H04W 48/16; H04W 4/00; H04W 76/02

(52) U.S. Cl. CPC H04W 48/16; H04W 76/02; H04W 4/008; H04W 84/12
USPC 370/338

(57) ABSTRACT

A method and an electronic device which is able to configure wireless communication using device names in the electronic device are provided. The method for wireless communication in the electronic device includes configuring communication connection information by designating device names to be used for connection with communication devices; and providing a communication service by establishing a wireless communication link to the communication device using the designated device name and communicating with the communication device. Configuring the communication connection information includes displaying a wireless communication configuration screen; displaying, upon selection of a device name displayed on the wireless communication configuration screen, a default device name of the communication device and a list of account names of accounts registered with the communication device; and designating an account name selected from the displayed list as a device name.

### PRIORITY

This application claims priority under 35 U.S.C. §119(a) to a Korean Patent Application filed on Sep. 3, 2013 in the Korean Intellectual Property Office and assigned Serial No. 10-2013-0105237, the entire disclosure of which is incorporated herein by reference.

### BACKGROUND

1. Field of the Invention

The present invention relates generally to a method and apparatus for configuring wireless communication in an electronic device, and more particularly, relates to a method and apparatus that can configure wireless communication using device names.

2. Description of the Related Art

Recent advances in various technologies have enabled popularization of electronic devices such as smartphones and Personal Digital Assistants (PDAs). Communication using electronic devices has also increased. An electronic device supports mobile communication based on CDMA, WCDMA or LTE and also support wireless local area communication such as Wi-Fi. In wireless local area communication, radio signals are used as transmission media so as to enable electronic devices in a short distance to exchange information. Examples of wireless local area communication include Wi-Fi Direct, Wi-Fi Hotspot, Bluetooth, and Near Field Communication (NFC).

In establishment of a wireless local area communication link, it is possible to identify a counterpart device through displayed device names. However, it is difficult to identify a counterpart device through device names as device-specific names are used.

That is, in the course of establishing a connection with another electronic device using Wi-Fi Direct, Bluetooth, Wi-Fi Hotspot and NFC, the electronic device is represented to other devices by its Service Set Identifier (SSID) or device identifier. In this case, the user may have difficulty in identifying a device to be linked and be inconvenienced by having to directly enter and change device names.

### SUMMARY

The present invention has been made to address at least the above mentioned problems and/or disadvantages and to provide at least the advantages described below. Accordingly, an aspect of the present invention is to provide a method and electronic device that can configure communication using user-provided device names in the electronic device. Specifically, the electronic device designates a device identifier to a device to be connected and establishes a communication link to the device using the device identifier. The device identifier may be a user name and/or a photograph.

In accordance with an aspect of the present invention, a method for wireless communication in an electronic device is provided. The method includes configuring communication connection information by designating device names to be used for connection with communication devices; and providing a communication service by establishing a wireless communication link to a communication device using a designated device name and communicating with the communication device. Configuring the communication connection information includes displaying a wireless communication configuration screen; displaying, upon selection of a device name displayed on the wireless communication configuration screen, a list, including a default device name of the communication device and account names; and designating an account name selected from the displayed list as a device name.

In accordance with another aspect of the present invention, an electronic device supporting wireless communication is provided. The electronic device includes a communication unit configured to establish a wireless communication link to a sender communication device or a receiver communication device through wireless local area communication; a display unit configured to display a registered account and data related to the registered account, upon activation of the wireless communication; and a control unit configured to designate a device name for the wireless local area communication by use of a preregistered account and data related to the account, and to control the display unit to display the designated device name, upon activation of wireless communication.

### BRIEF DESCRIPTION OF THE DRAWINGS

The above and other aspects, features, and advantages of certain embodiments of the present invention will be more apparent from the following detailed description taken in conjunction with the accompanying drawings, in which:

FIG. 1 is a block diagram of an electronic device, according to an embodiment of the present invention;

FIG. 2 is a flowchart of a procedure for designating device names, according to an embodiment of the present invention;

FIGS. 3A-3F are screen representations illustrating device name designation, according to an embodiment of the present invention;

FIG. 4 is a flowchart of a procedure for performing communication using designated device names, according to an embodiment of the present invention;

FIG. 5 is a flowchart of a sender mode configuration procedure during activation of wireless communication, according to an embodiment of the present invention;

FIGS. 6A-6C are screen representations illustrating sender mode configuration steps during activation of wireless communication, according to an embodiment of the present invention;

FIG. 7 is a flowchart of a receiver mode configuration procedure during activation of wireless communication, according to an embodiment of the present invention; and

FIGS. 8A and 8B are screen representations illustrating receiver mode configuration steps during activation of wireless communication, according to an embodiment of the present invention.

### DETAILED DESCRIPTION OF EMBODIMENTS OF THE PRESENT INVENTION

Hereinafter, embodiments of the present invention are described in detail with reference to the accompanying drawings. The same reference symbols are used throughout the drawings to refer to the same or like parts. Detailed descriptions of well-known functions and structures incorporated herein is omitted to avoid obscuring the subject matter of the present invention.

It should be apparent to those skilled in the art that the following description of various embodiments of the present invention is provided for illustration purposes only and not for the purpose of limiting the present invention, and various changes and modifications are possible on the basis of the following description.

In various embodiments of the present invention, the electronic device is one of a mobile terminal, mobile communication terminal, smartphone, tablet computer, hand-held personnel computer, Portable Multimedia Player (PMP), Personal Digital Assistant (PDA), and laptop computer.

In a feature of the present invention, the electronic device may designate a user supplied device identifier to an external electronic device to be linked as a device identifier, and establish a wireless communication link to the external electronic device using the designated device identifier. The electronic devices may be interconnected through Wi-Fi Direct, Bluetooth, Wi-Fi Hotspot, and NFC. Device identifiers may be user names of accounts registered on the electronic device. In addition, a profile photograph is designated together with a device name, making the counterpart device readily identifiable during wireless communication between electronic devices. Hence, it is possible to provide a more realistic user experience during wireless communication establishment, by designating a familiar name and profile photograph as a device identifier.

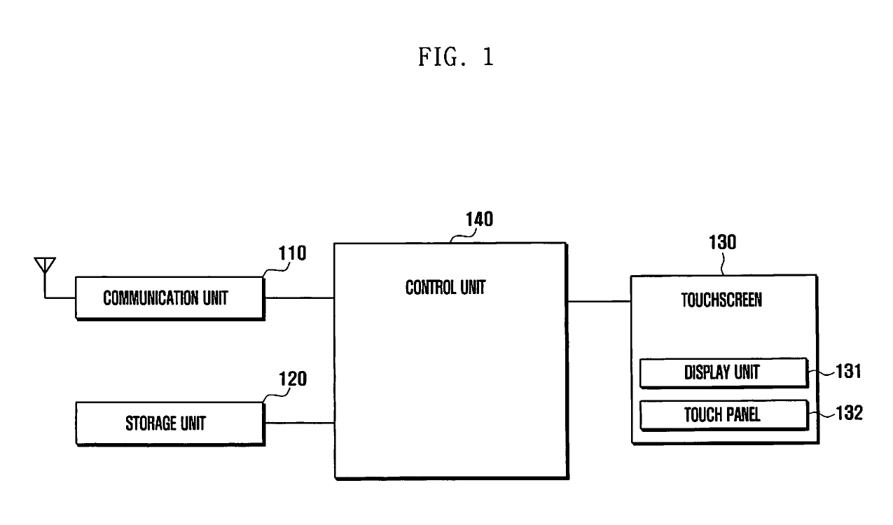

FIG. 1 is a block diagram of an electronic device, according to an embodiment of the present invention.

Referring to FIG. 1, the electronic device includes a communication unit 110, a storage unit 120, a touchscreen 130, and a control unit 140.

The communication unit 110 performs communication for voice, video and data calls with an external entity through a network. The communication unit 110 may include a radio frequency (RF) transmitter, for upconverting the frequency of a signal to be transmitted and amplifying the signal, and an RF receiver, for low-noise amplifying a received signal and downconverting the frequency of the received signal. The communication unit 110 may further include a modulator and a demodulator. Modulation and demodulation may be performed according to various communication schemes including CDMA, WCDMA, LTE, Wi-Fi, WiBro, Bluetooth and NFC. The communication unit 110 may include a mobile communication module, an Internet communication module, and a local area (or short-range) communication module.

In particular, the communication unit 110 may include an LTE communication module and local area communication modules supporting Wi-Fi, Wi-Fi Direct, Bluetooth, Wi-Fi Hotspot and NFC.

The storage unit 120 includes a program region to store programs of the electronic device, and a data region to store data generated during program execution.

In particular, the storage unit 120 includes a database to store a user account registered in the electronic device and data associated with the account. The user account may be an email account, Social Networking Service (SNS) account, or the like. The data associated with the account may include a profile photograph, day/month/year of birth, nickname, or the like.

The touchscreen 130 may be an integration of a display unit 131 and a touch panel 132. The display unit 131 displays various screens in the course of operation of the electronic device under control of the control unit 140. The display unit 131 may be realized using a Liquid Crystal Display (LCD) or Organic Light Emitting Diodes (OLEDs). The touch panel 132 may be a composite of a hand touch panel sensing a hand gesture and a pen touch panel sensing a pen gesture. The hand touch panel may be realized using capacitive, resistive, infrared, or surface acoustic wave technology. The pen touch panel may be realized using electromagnetic induction technology.

In particular, the display unit 131 displays an account list stored in the storage unit 120 under control of the control unit 140. When an account is selected from the displayed account list through the touch panel 132, the display unit 131 displays the selected account as a device name. When wireless communication is activated, the display unit 131 displays device names of connectable sender or receiver devices and account related data such as profile photographs.

The control unit 140 controls the overall operation of the electronic device, controls signal exchange between components of the electronic device, performs data processing, and controls the supply of power from a battery to the components.

In particular, the control unit 140 controls the display unit 131 to display an account list for device name designation. The account list is a list of accounts registered in the electronic device and is stored in the storage unit 120. When an account is selected from the displayed account list through the touch panel 132, the control unit 140 designates the selected account as a device name and controls the display unit 131 to display the device name. When data associated with the account is present, the control unit 140 controls the display unit 131 to display the data together with the device name. The control unit 140 controls wireless communication between sender and receiver devices.

If necessary, the electronic device may further include a Global Positioning System (GPS) module to receive location information, an audio processing unit, including a microphone and speaker, a camera module to capture a still or moving image of a target object, an input unit having physical keys, and the like. A description of these additional components is omitted.

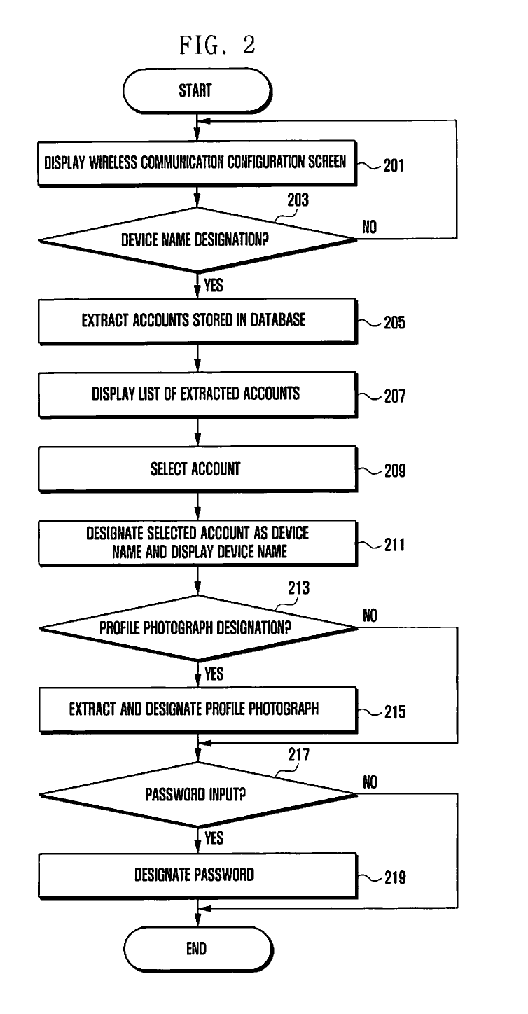

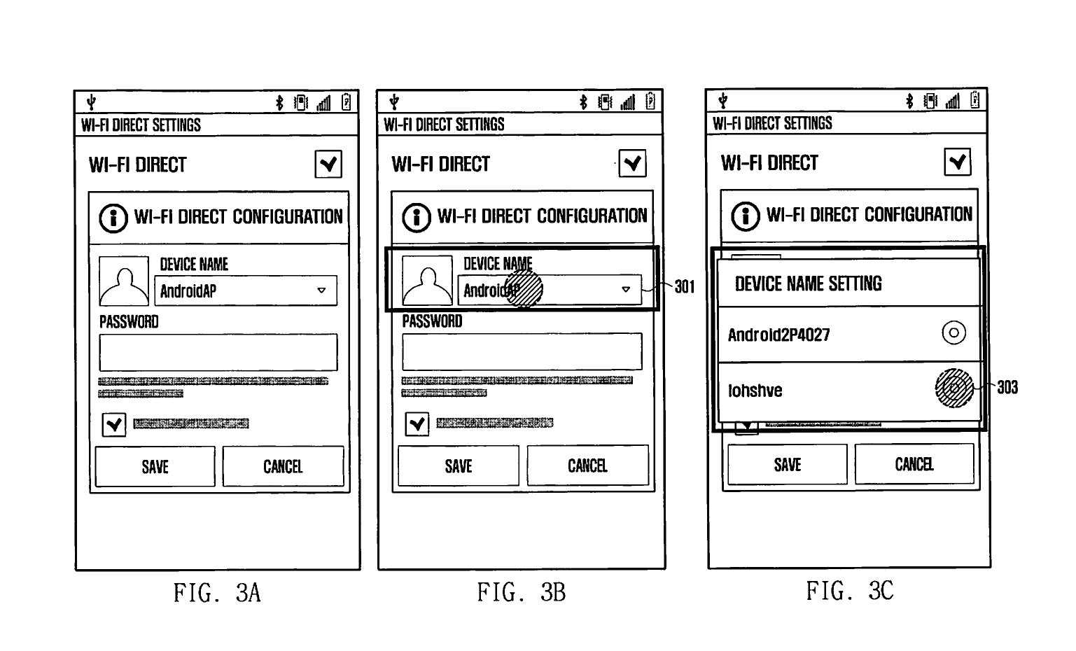

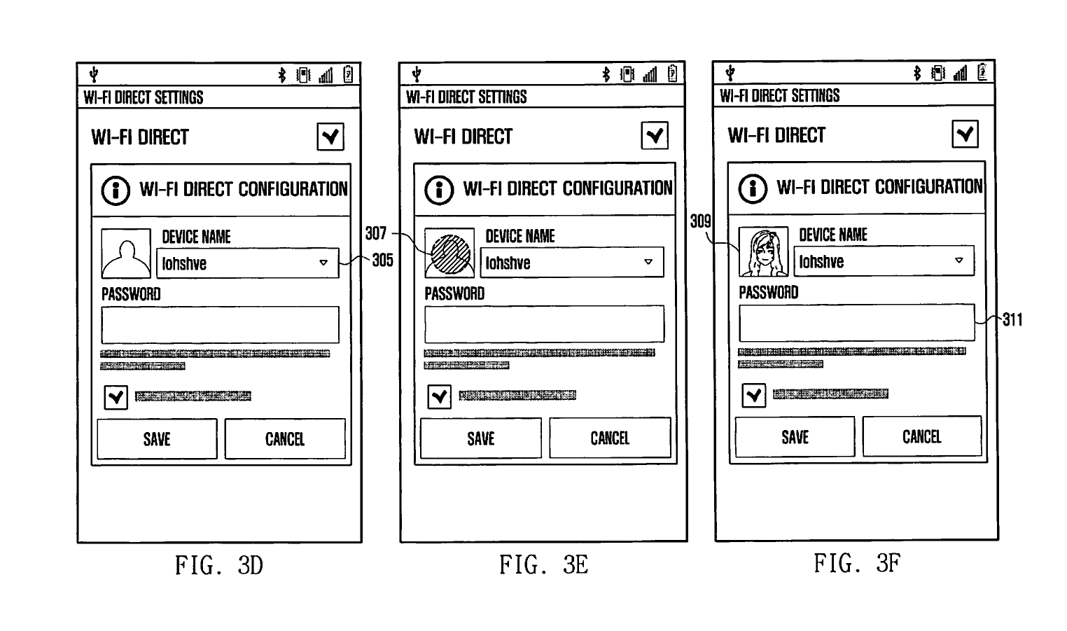

FIG. 2 is a flowchart of a procedure for designating device names, according to an embodiment of the present invention. FIGS. 3A-3F are screen representations illustrating device name designation, according to an embodiment of the present invention.

Referring to FIG. 2 and FIGS. 3A-3F, at step 201, the control unit 140 controls the display unit 131 to display a wireless communication configuration screen, according to a selection of a mode for device name designation (e.g. “environment settings”). Using the wireless communication configuration screen, a device name, profile photograph, and password may be designated to distinguish one electronic device from other electronic devices. When Wi-Fi Direct is used for wireless communication, the control unit 140 controls the display unit 131 to display a screen as shown in FIG. 3A. The device name is used for identifying a device to be connected during wireless communication, and may be a unit name, SSID, or brand name. Wi-Fi Direct, Bluetooth, NearBy, NFC, or the like may be used to interconnect electronic devices. In the following description, a device name is designated when Wi-Fi Direct is used.

The user may have difficulty in identifying an electronic device using a default device name such as SSID or brand name. The present invention enables the user to utilize a frequently used ID (e.g. SNS account or Google account) as a device name. For a device name designation, the control unit 140 displays a frequently used name (account information) together with a default device name (SSID or brand name), and designates a name selected by the user as a device identifier.

Upon display of the wireless communication configuration screen, at step 203, the control unit 140 determines whether an input for device name designation is detected on the wireless communication configuration screen. When an input for selecting a device name through the touch panel 132 (e.g. tap) is detected, the control unit 140 regards this as an input for device name designation.

For example, when a device name is tapped as indicated by reference numeral 301 in FIG. 3B, the control unit 140 detects the tap as an input for device name designation. At step 205, the control unit 140 extracts accounts stored in a database in the storage unit 120. At step 207, the control unit 140 displays a list of account names along with the default device name, as shown in FIG. 3C. The account name may be a name of an email account or a SNS account registered in the electronic device. Data associated with the accounts may also be stored in the database. Data associated with an account may include a profile photograph, day/month/year of birth, nickname, or the like.

At step 209, the control unit 140 selects an account name or the default device name from the displayed account list as indicated by reference numeral 303 in FIG. 3C. At step 211, the control unit 140 designates the selected name as a designated device name and displays the designated device name as indicated by reference numeral 305 in FIG. 3D.

If no input for selection of the designated device name is detected, the control unit 140 returns to step 203 and waits for an input for selection of the designated device name. In addition to device name designation, supplementary information on the user may be added. In the following description, supplementary information on the user is assumed to be a profile photograph.

At step 213, the control unit 140 determines whether an input for designating a profile photograph is detected. When an input for selecting a profile photograph through the touch panel 132 (e.g. tap) is detected, the control unit 140 regards this as an input for designating a profile photograph. For example, when the user taps a profile photograph on a device name designation screen as indicated by reference numeral 307 in FIG. 3E, at step 215, the control unit 140 extracts the profile photograph and designates the profile photograph as supplementary information for the device name as indicated by reference numeral 309 in FIG. 3F. That is, when a profile photograph is stored in the storage unit 120 as part of account related data and the profile photograph is selected, the control unit 140 designates the profile photograph together with the device name. A photograph selected from a photo album stored in the electronic device may be designated as a profile photograph. A photograph taken by a camera may also be designated as a profile photograph. When a profile photograph is not selected, the control unit 140 designates the selected account as a device name.

Thereafter, at step 217, the control unit 140 determines whether a password is input in a password input field through the touch panel 132 as indicated by 311 in FIG. 3F. When a password is input, at step 219, the control unit 140 designates the password as supplementary information.

The control unit 140 designates a device name (and supplementary information) through the procedure depicted in FIG. 2, and then is able to establish a communication link to a corresponding device using the designated device name.

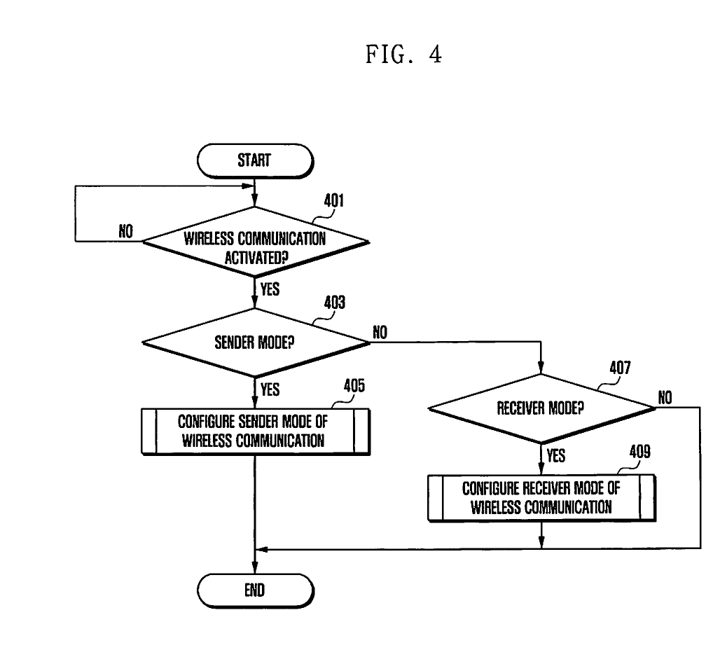

FIG. 4 is a flowchart of a procedure for performing communication using designated device names, according to an embodiment of the present invention.

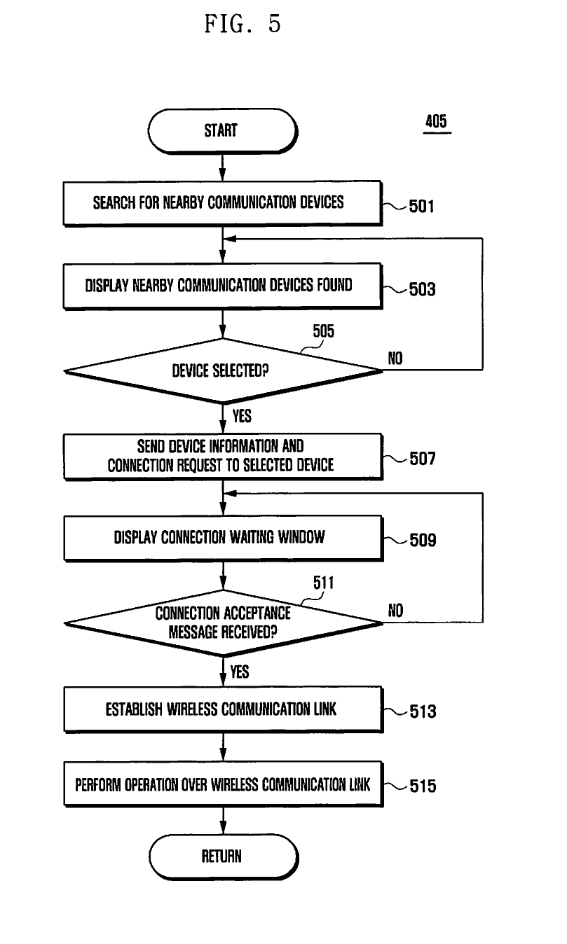

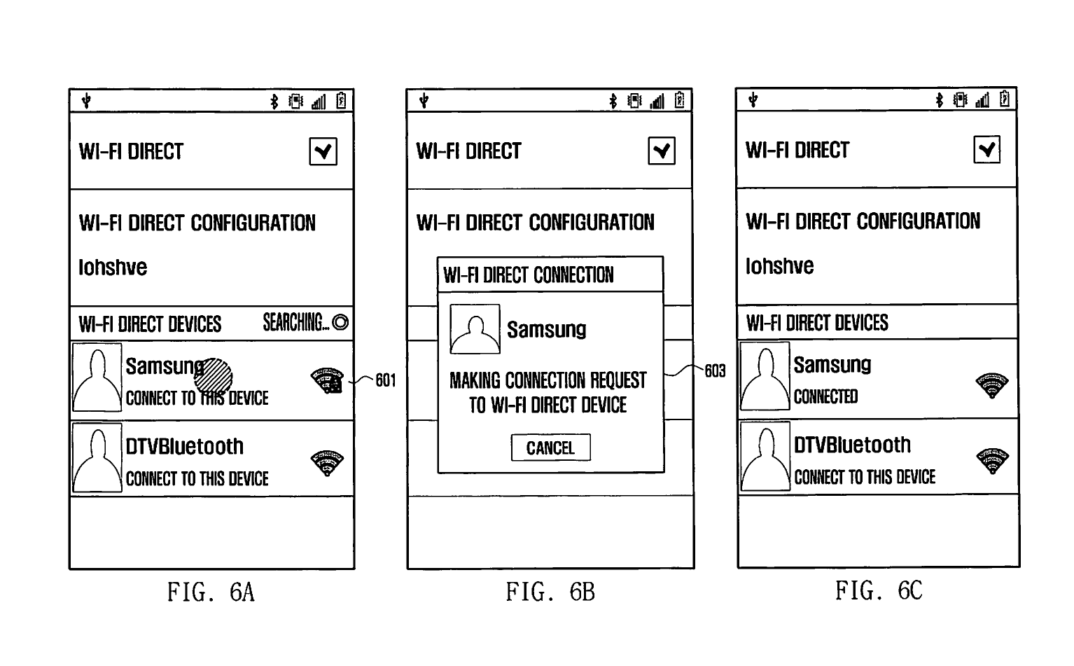

Referring to FIG. 4, at step 401, the control unit 140 checks whether wireless communication is activated. Wireless communication may indicate transmission to or reception from a communication device through wireless local area (or short-range) communication. Wireless communication may also indicate direct communication between communication devices using communication schemes including Wi-Fi Direct, Bluetooth, NearBy and NFC. If wireless communication is activated, the procedure proceeds to step 403 at which the control unit 140 checks whether sender mode is desired. If sender mode is desired, the procedure proceeds to step 405. At step 405, the control unit 140 configures the sender mode of the communication device. That is, the control unit 140 finds communication devices in the vicinity thereof and controls the display unit 131 to display the designated device names of the found communication devices. The designated device name may be an account name (and a profile photograph) designated by the user. When one of the displayed device names is selected, the control unit 140 sends the selected device name to the corresponding communication device to establish a communication link thereto. Step 405 of FIG. 4 is described in more detail with reference to FIG. 5 and FIGS. 6A-6C.

FIG. 5 is a flowchart of a sender mode configuration procedure during activation of wireless communication, according to an embodiment of the present invention. FIGS. 6A-6C are screen representations illustrating sender mode configuration operations during activation of wireless communication, according to an embodiment of the present invention.

Referring to FIG. 5 and FIGS. 6A-6C, at step 501, the control unit 140 controls the communication unit 110 to collect information regarding nearby communication devices that are activated for wireless communication. At step 503, the control unit 140 controls the display unit 131 to display a list of nearby communication devices found as shown in FIG. 6A. The list of communication devices may include not only designated device names but also profile photographs. When a profile photograph is not designated for a communication device in the list, the sender device may designate a profile photograph for easy identification of the user of the communication device. Although a profile photograph is designated for a communication device in the list, the user of the sender device may replace the profile photograph with a desired profile photograph for the communication device.

At step 505, the control unit 140 checks whether a communication device to which a communication link is to be established is selected from the list. For example, when a communication device is selected as indicated by reference numeral 601 in FIG. 6A, the procedure proceeds to step 507 at which the control unit 140 sends device information and a connection request message to the selected communication device. The device information may include a device name, profile photograph, network address, and the like. When a communication device is not selected, the procedure returns to step 503.

After sending the connection request message, at step 509, the control unit 140 controls the display unit 131 to display a connection waiting window. As indicated by reference numeral 603 in FIG. 6B, the connection waiting window may contain a designated device name and profile photograph for the selected communication device. The displayed designated device name and profile photograph enable easy identification of the user of the selected communication device.

At step 511, the control unit 140 checks whether a connection acceptance message is received from the selected communication device. When a connection acceptance message is received, the procedure proceeds to step 513 at which the control unit 140 confirms establishment of a wireless communication link to the selected communication device as shown in FIG. 6C. When a connection acceptance message is not received, the procedure returns to step 509. After establishment of a wireless communication link, at step 515, the control unit 140 is able to communicate data with the connected communication device. Data such as a music file, video file, photograph file, memos, and contact information may be sent to the communication device.

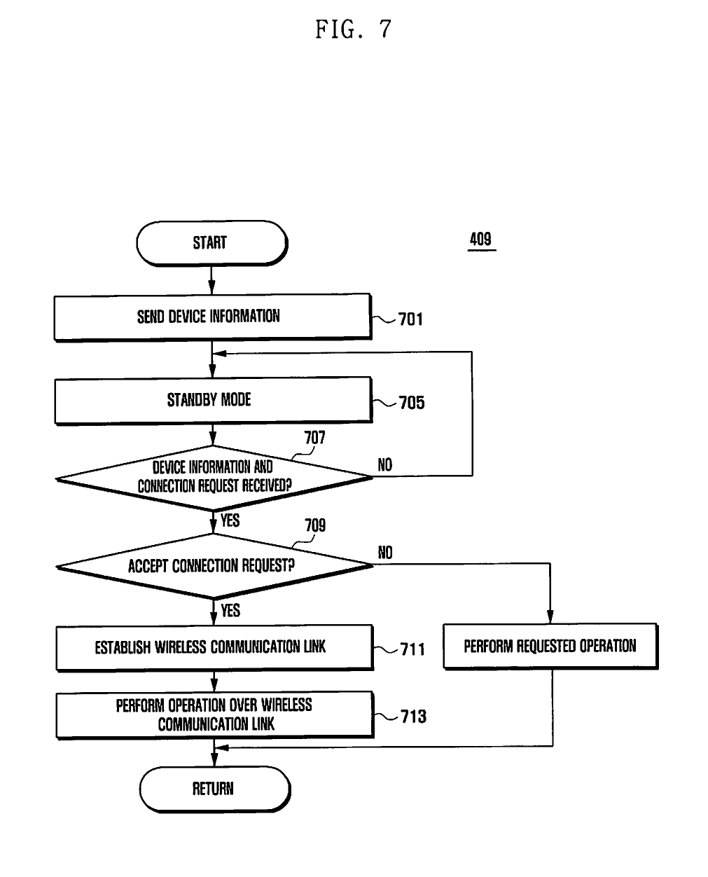

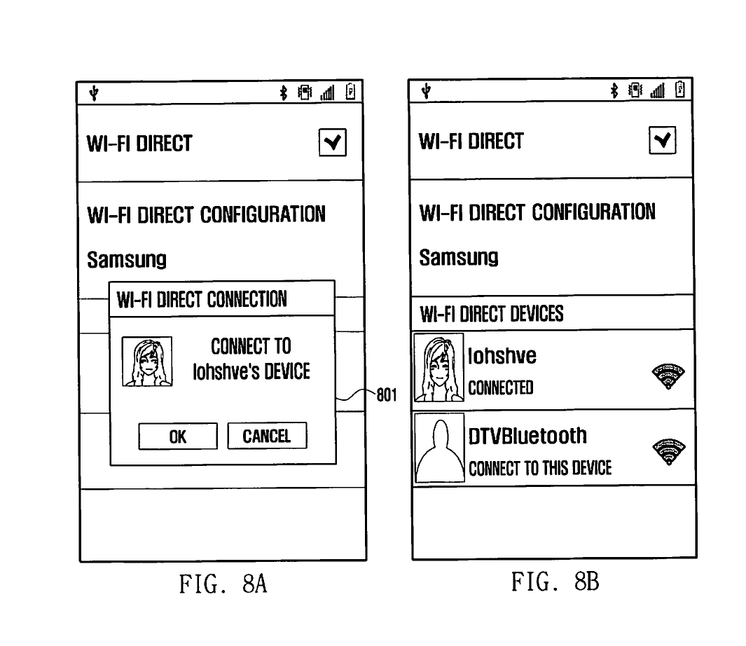

Referring back to FIG. 4, at step 407, the control unit 140 checks whether receiver mode is desired. That is, whether a connection request is received from a nearby communication device is checked. If a connection request is received, the procedure proceeds to step 409. At step 409, the control unit 140 configures the receiver mode of the communication device. That is, the control unit 140 displays a device name of the counterpart communication device which is requesting a connection. If the connection request is accepted, the control unit 140 establishes a wireless communication link to the counterpart communication device and provides a communication service. The device name may be an account name designated by the counterpart communication device, and may include a profile photograph. Hence, the user of the electronic device may view the account name (and profile photograph) on the display unit 131 and may readily identify the counterpart user. Step 409 of FIG. 4 is described in more detail with reference to FIG. 7 and FIGS. 8A and 8B.

FIG. 7 is a flowchart of a receiver mode configuration procedure during activation of wireless communication, according to an embodiment of the present invention. FIGS. 8A and 8B are screen representations illustrating receiver mode operations during activation of wireless communication, according to an embodiment of the present invention.

Referring to FIG. 7 and FIGS. 8A and 8B, at step 701, the control unit 140 controls the communication unit 110 to transmit device information to communication devices. The device information may include a device name, profile photograph, network address, and the like. At step 705, the control unit 140 enters standby mode to receive a connection request message from a communication device in the vicinity. During standby mode, at step 707, the control unit 140 checks whether device information and a connection request message are received from a sender communication device. If a connection request message is received from a sender communication device, at step 709, the control unit 140 determines whether to accept the connection request. As indicated by reference numeral 801 in FIG. 8A, the connection request message is displayed together with device information of the communication device having sent the connection request message. The device information may include a device name and profile photograph. Through the displayed device name and profile photograph, the user of the communication device having sent the connection request message may be readily identified. When a connection request message is not received, the procedure returns to step 705.

Upon determining to accept the connection request, at step 711, the control unit 140 confirms establishment of a wireless communication link to the sender communication device as shown in FIG. 8B. After establishment of a wireless communication link, at step 713, the control unit 140 is able to communicate data with the sender communication device. Data such as a music file, video file, photograph file, memos, and contact information may be received from the sender communication device. Upon determining not to accept the connection request, the control unit 140 may send a connection rejection message and may perform a requested operation.

Referring back to FIG. 4, when no wireless communication is performed with a nearby communication device, the control unit 140 may examine the state of wireless communication, release a wireless communication link, or deactivate wireless communication.

Hereinabove, embodiments of the present invention have been described with reference to the accompanying drawings. Specific terms or words used in the description should be construed in accordance with the spirit of the present invention without limiting the subject matter thereof. It should be understood that many variations and modifications of the basic inventive concept described herein will still fall within the spirit and scope of the present invention as defined in the appended claims and their equivalents.

What is claimed is:

1. A method for wireless communication in an electronic device, the method comprising:
configuring communication connection information by designating device names to be used for connection with communication devices; and
providing a communication service by establishing a wireless communication link to a communication device using a designated device name and communicating with the communication device,
wherein configuring the communication connection information comprises:
displaying a wireless communication configuration screen;
displaying, upon selection of a device name displayed on the wireless communication configuration screen, a list, including a default device name of the communication device and account names; and
designating an account name selected from the displayed list as a device name.

2. The method of claim 1, wherein communication with the communication device is performed through local area communication.

3. The method of claim 2, wherein the local area communication is based on at least one of Wi-Fi, Wi-Fi Direct, Wi-Fi Hotspot, Bluetooth, NearBy and Near-Field Communication (NFC).

4. The method of claim 2, wherein the account names comprise at least one of an email account name and a Social Networking Service (SNS) account name.

5. The method of claim 4, wherein designating the account name further comprises designating a user image, related to the account name, as supplementary information.

6. The method of claim 4, wherein providing the communication service comprises:
providing, in sender mode, a transmission service by sending communication connection information, including the designated device name, to a receiver communication device, and establishing, according to a response from the receiver communication device, the wireless communication link to the receiver communication device; and
providing, in receiver mode, a reception service by displaying a device name received from a sender communication device, and establishing, according to a response from a user, the wireless communication link to the sender communication device.

7. The method of claim 6, wherein providing the transmission service comprises:
collecting information on nearby communication devices;
displaying device names of the nearby communication devices; and
establishing a wireless communication link to a nearby communication device corresponding to a selected device name.

8. The method of claim 6, wherein providing the reception service comprises:
sending the device name; and
establishing, upon reception of a connection request from the sender communication device, the wireless communication link to the sender communication device.

9. An electronic device supporting wireless communication, comprising:
a communication unit configured to establish a wireless communication link to a sender communication device or a receiver communication device through wireless local area communication;
a display unit configured to display a registered account and data related to the registered account, upon activation of the wireless communication; and
a control unit configured to designate a device name, for the wireless local area communication by use of a preregistered account and data related to the account, and to control the display unit to display the designated device name, upon activation of the wireless communication.

10. The electronic device of claim 9, wherein the control unit is further configured to establish a communication link through at least one of Wi-Fi, Wi-Fi Direct, Wi-Fi Hotspot, Bluetooth, NearBy and NFC.

11. The electronic device of claim 10, wherein the account is at least one of an email account and an SNS account.

12. The electronic device of claim 11, wherein the control unit is further configured to designate a user image, related to the account, as supplementary information.

13. The electronic device of claim 10, wherein the control unit is further configured to establish, upon activation of the wireless communication, the wireless communication link to the sender communication device or the receiver communication device, and provides a communication service.

14. The electronic device of claim 13, wherein, in sender mode, the control unit is configured to collect information on nearby communication devices, display device names of the nearby communication devices, and establish the wireless communication link to a nearby communication device corresponding to a selected device name.

15. The electronic device of claim 13, wherein, in receiver mode, the control unit is configured to send the designated device name, and establish, upon reception of a connection request from a sender communication device, the wireless communication link to the sender communication device.

16. The electronic device of claims 14, wherein the control unit is configured to control the display unit to display both an account name of a registered account, designated as the device name, and data related to the registered account.

17. The electronic device of claims 15, wherein the control unit is configured to control the display unit to display both an account name of a registered account, designated as the device name, and data related to the account.
